(19) United States
(12) Patent Application Publication
(10) Pub. No.: US 2008/0269362 A1
(43) Pub. Date: Oct. 30, 2008

(54) Recycled thermosetting flour composites and method for preparing the same

(75) Inventors: Chen-Feng Kuan, Taichung County (TW); Chia-Hsun Chen, Taichung City (TW); Min-Chi Chung, Taichung County (TW); Hsu-Chiang Kuan, Kaohsiung City (TW); Kun-Chang Lin, Tainan City (TW); Hsin-Chin Peng, Taichung City (TW)

Correspondence Address: HUDAK, SHUNK & FARINE, CO., L.P.A., 2020 FRONT STREET, SUITE 307, CUYAHOGA FALLS, OH, 44221, US

(73) Assignee: FAR EAST UNIVERSITY, Tainan (TW)

(21) Appl. No.: 12/070,527

(22) Filed: Feb. 19, 2008

(30) Foreign Application Priority Data
Apr. 24, 2007 (TW) 096114503

(51) Int. Cl. C08J 11/04; C08L 83/00; C08L 1/02; C08K 3/22

(52) U.S. Cl. 521/40; 525/474; 525/106; 524/35; 524/436; 524/437; 524/80

(57) ABSTRACT

The recycled thermosetting flour composites and method for preparing the same are disclosed. The silane coupling agent is used as a coincidental bridge between recycled thermosetting flour and plastic materials, to apparently promote the mechanical properties of composites by linking with each other. As a result, the recycled polyolefin and recycled thermosetting flour are applied through interfacial modification, coupling, modification, mixing and granulating process to generate a composite with better mechanical properties and recycle the resource.

### BACKGROUND OF THE INVENTION

(a) Field of the Invention

The present invention is related to a recycled thermosetting flour composites and method for preparing the same, and more particularly to the technology of adopting the recycled plastic and printed circuit board (PCB) flour to produce composites and related products.

(b) Description of the Prior Art

Among the solid waste produced from Taiwan, the percentage of wood and paper is about 25.13% to 34.12% and the content of plastic is about 16.9% to 19.72. Therefore, we should make full use and recycle of the solid waste to achieve the goal of waste decrement and resourcezation.

Recycling of wastes of the electrical and electronic equipment (WEEE) foreseen in the new European (EU) Directive on the waste of electrical and electronic equipment (WEEE Directive) is based on the experience of a few European Countries. The organizations managing voluntary take back systems on behalf of the EEE producers have been responsible for the collection and recycling of the WEEE. The treatment of plastics will be encouraged as a consequence of the implementation of both the landfill directive (ban on dumping high calorific valued waste-plastics) and the incineration directive, which encourages handling (incineration) high calorific waste for energy recovery. Copper clad laminate (CCL) is a basic component in the electrical and electronic equipment. The reuse of CCL plays an important role in the recycling of WEEE.

Printed circuit board (PCB) is widely applied to the base component concerned with various electronic products. The major materials of PCB include substrates, copper laminates and chemical. The substrates can be divided into paper material, composite material, glass cloth material, polyester fiber and polyamide fiber. Besides, the particular substrates include metal substrate, thermoplastic substrate and ceramic substrate. The applications of PCB range over the whole 3C industries, such as information, communications, electrics, aerospace, military and industrial instruments.

The 3C products can improve quality of life, but their high replacement rate results in serious environmental pollution if not recycling the resource. Moreover, in the past five decades, the applications of composite materials are related among all kinds of industries, such as household goods, athletic equipment, recreation facility, automobile, aircraft, space shuttle and so forth. All the synthetic polymers including thermoplastic, thermosetting or elastomer can be used as substrates. Especially about the reinforced materials, these are fairly expensive except for the vegetable fiber and glass fiber.

The complex composition of PCB makes it hard to be recycled. Hence, most of wastes PCB are treated with being buried in landfill. It is an urgent problem about how to make good use of the resource on earth in order to efficiently reduce the usage of wood to reserve the forest, and to recycle the waste.

Crosslinking with water is achieved by grafting polyethylene with silane followed by the hydrolysis to Si—OH groups and subsequently condensation to form Si—O—Si bonds. This process is through free radical initiators and can subsequently condense through water, leading to the formation of crosslinking. Crosslinked polyethylene has become widely adapted for a number of industrial applications. Cross-linking of polyethylene molecules into three-dimensional networks leads to improvement of material properties such as impact strength, chemical resistance, and thermal characteristics.

Adding PCB flour to thermoplastic resins can produce composite materials with increased strength and stiffness. Due to the different characters of the polyolefin matrix and filler, both filler and polymeric matrix have to be chemically modified to improve the interfacial compatibilization. Adding a suitable interface modifier will promote the stability of the morphology in incompatible polymer-fiber composites. Such modifiers improve the composite morphology by more finely dispersing the discontinuous filler or fiber in the dominant polymer matrix. In the present work, silane coupling agent and polyolefin elastomer grafted with melaic acid (POE-g-MA) compatibilizer is used as an interface modifier, which was chemically bonded to both the PCB flour and the polymer matrix. A strong interfacial adhesion between reinforcement and matrix is extremely important to develop polymer composites with improved physical and mechanical properties.

In view of the drawbacks of the prior art, the inventor of the present invention based on years of experience in the related industry to conduct extensive researches and experiments, and finally developed a the recycled thermosetting flour composites and method for preparing the same in accordance with the present invention to overcome the aforementioned drawbacks.

### SUMMARY OF THE INVENTION

The primary purpose of the present invention is to provide a recycled thermosetting flour composite and method for preparing the same so as to enhance the mechanical properties of the recycled thermosetting flour composite.

To achieve the purpose, the present invention provides a recycled thermosetting flour composite including a plastic material, recycled thermosetting flour, an organic unsaturated silane and a compatibilizer.

Furthermore, the present invention discloses a method for preparing the recycled thermosetting flour composite, and the method includes the following steps of:
(a) providing a plastic material, recycled thermosetting flour, an organic unsaturated silane and a compatibilizer;
(b) dispersing the organic unsaturated silane by using a dispersant for mixing with the thermosetting flour uniformly; and
(c) processing a water-crosslinking reaction with the mixture made from step (b) and the plastic material, for leading the thermosetting flour and the plastic material to form a Si—O—Si bonding by way of silicon of the organic unsaturated silane.

In addition, the composite material of the present invention is synthesized by the process of precision intermixing, granulating, processing and molding, and the composite material further including a fiber filler or inorganic filler, antiager, ultraviolet stabilizer and fire retardant such as Mg(OH)₂, Al(OH)₃, phosphorous compound or nitrogen compound.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

The subject matter regarded as the invention is particularly pointed out and distinctly claimed in the concluding portion of the specification. The invention together with features and advantages thereof may best be understood by reference to the following detailed description with the accompanying drawings in which:

FIG. 1 illustrates a process flow diagram of method for preparing a recycled thermosetting flour composite in accordance with the present invention;

FIG. 2 illustrates a schematic view of chemical structural formula of the combination of the thermosetting flour and the plastic material in accordance with the present invention;

FIG. 3A illustrates a comparison table of the tensile strength of PCB flour reinforced LLDPE composites with various PCB flour contents and various treatment methods;

FIG. 3B illustrates a tensile strength comparison table of silane treated PCB flour reinforced LLDPE composites with various PCB flour contents for various water-crosslinking times of present invention;

FIG. 4A illustrates a comparison table of flexural strength of PCB flour reinforced LLDPE composites with various PCB flour contents and various treatment methods of present invention;

FIG. 4B illustrates a comparison table of flexural modulus of PCB flour reinforced LLDPE composites with various PCB flour contents and various treatment methods of present invention;

FIG. 4C illustrates a comparison table of flexural strength of silane treated PCB flour reinforced LLDPE composites with various PCB flour contents for various water-crosslinking times of present invention; and

FIG. 4D illustrates a comparison table of flexural modulus of silane treated PCB flour reinforced LLDPE composites with various PCB flour contents for various water-crosslinking times of present invention.

### DETAILED DESCRIPTION OF THE PREFERRED EMBODIMENTS

The present invention relates to a recycled thermosetting flour composites and method. While the specifications describe at least one embodiment of the invention considered best modes of practicing the invention, it should be understood that the invention can be implemented in many ways and is not limited to the particular examples described below or to the particular manner in which any features of such examples are implemented.

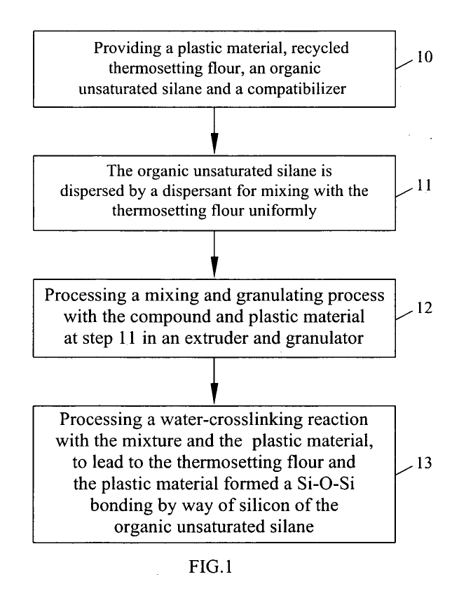

Please referring to FIG. 1 for a process flow diagram of method for preparing a recycled thermosetting flour composite of the present invention, the method includes the following steps of:

Step 10: providing a plastic material, recycled thermosetting flour, an organic unsaturated silane and a compatibilizer. Preferably, the compatibilizer is related to which's chemical formula is R-g-X, in which said R is a macromolecule chain harmonized with the plastic material, in which said X is the functional group strongly reacted with —OH group such as MA and AA etc. For example, polyolefin elastomer grafted with melaic acid compatibilizer (POE-g-MA). Preferably, the plastic material includes at least the thermoplastic flour related to the polyolefin such as polyethylene (PE) or polypropylene (PP), and the thermosetting flour related to the recycled phenolic cellulose paper, the epoxy resin-glass cloth laminate flour or recoveries concerned about SMC and BMC.

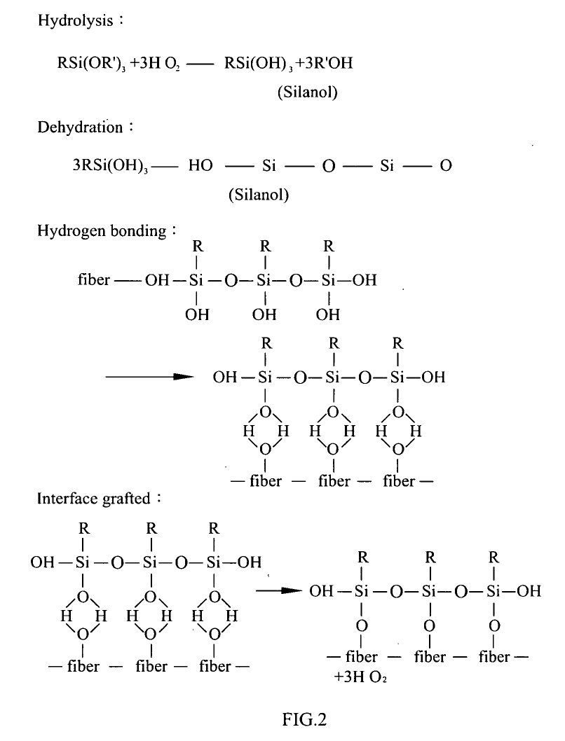

The organic unsaturated silane includes ethane, propane, 2-methylpropane, pentane, 2-methylbutane or silane coupling agent which's chemical formula is conformed to YRSiX₃, which X represents the hydrolytable alkoxy group, Y represents a functional group, and R represents a proper carbon chain such as the aliphatic chain. As the chemical structural formula of combination of the thermosetting flour and the plastic material shown in FIG. 2, the silane coupling agent (RSi(OR′)₃) is mixed with water for hydrolytic reaction to obtain a silanol compound. Then, a dehydration reaction with the silanol compound is proceeded to obtain a siloxane compound, and subsequently the hydrogen bonding is formed between the siloxane and fiber, then, a dehydration reaction is proceeded in order to be surface grafted with silane coupling agent and fiber. In embodiment, the thermosetting flour is related to the PCB cellulose paper flour, and the organic unsaturated silane is related to the ethyl-silane coupling agent.

Step 11: dispersing the organic unsaturated silane by using a dispersant for mixing with the thermosetting flour uniformly. In embodiment, the dispersant can be an acetone. PCB cellulose paper flour treated with VTMOS silane coupling agent 2 phr (part per hundred parts of resin) surface treatments is mixed by Hancel mixer, and dried to reduce the moisture.

Because the functional group of the coupling agent tends to lose function as a result of reacting with water. Therefore, most of the moisture has to be removed from the PCB cellulose paper flour and then the acetone solution with coupling agent is added.

If necessary, an initiator can added in the mixture when step 11 is executed. Preferably, the initiator is related to dicumyl peroxide (DCP), α-α-xylene, 2,5-dimethyl-2,5-dihexane, dibenzoxylperoxide, dicumylperoxide, 2-terbutylperoxide, terbutylcumylperoxide, peroxyterbutyltervalerate or peroxy-2-ethylterbutylcaproate.

Also, the organic metal compound is able to be applied at step 11 as a catalyst, and the organic metal compound at least includes dibutyltin dilaurate, dibutyltin diacetate, dibutyltin dicaprylate, stannous acetate, tetrabutyltitanate, lead naphthoate, zinc caprylate, calcium stearate, lead stearate, cadmium stearate.

Step 12: processing a mixing and granulating process with the compound and plastic material generated at step 11 in an extruder and granulator.

In one embodiment, proper proportions of recycled PCB cellulose paper flour and one treated with a silane coupling agent treatment are individually mixed with the plastic material in the Banbury mixer. Then the extruder is prepared, and preceding the injected specimen of ASTM shaped specimen.

Step 13: processing a water-crosslinking reaction with the mixture and the plastic material, for leading the thermosetting flour and the plastic material to form a Si—O—Si bonding by way of silicon of the organic unsaturated silane.

In addition, the prevent invention further includes a step of adding cellulose filler, inorganic filler, antiager, ultraviolet stabilizer and fire retardant such as Mg(OH)₂, Al(OH)₃, phosphorous compound or nitrogen compound.

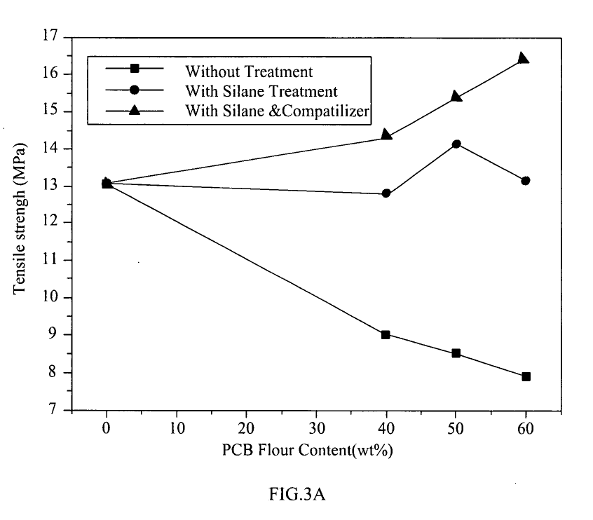

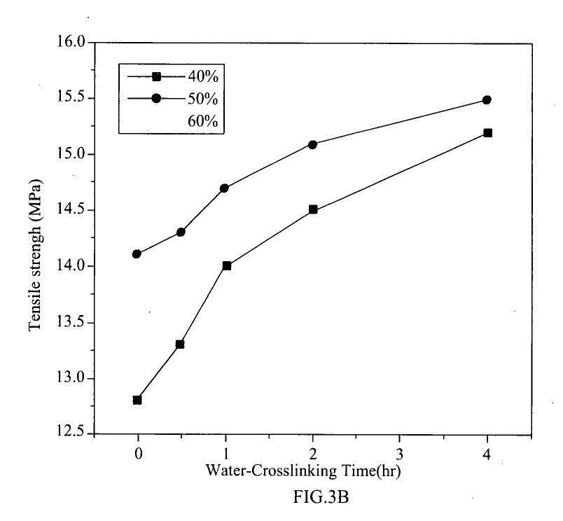

Please referring to FIG. 3A for a comparison table of the tensile strength of PCB flour reinforced LLDPE composites with various PCB flour contents and various treatment methods, [symbol] represents the tensile strength of composite with recycled PCB cellulose paper flour without treatment. [symbol] represents the tensile strength of composite with recycled PCB cellulose paper flour with silane treatment. [symbol] represents the tensile strength of composite with recycled PCB cellulose paper flour with silane and compatibilizer treatment. The result reveals that the tensile strengths of composites with silane treatment, and the tensile strengths of composites with silane and compatibilizer treatment are both better than the tensile strengths of composites with silane treatment without treatment as the contents of the recycled PCB cellulose paper flour increases.

Please referring to FIG. 3B for a comparison table of the tensile strength of PCB flour reinforced LLDPE composites with various PCB flour contents and various treatment methods, [symbol] represents the tensile strength of composite with content for 40% PCB cellulose paper flour, and [symbol] represents the tensile strength of composite with content for 50% PCB cellulose paper flour, and [symbol] represents the tensile strength of composite with content for 60% PCB cellulose paper flour.

The tensile strength of composites is promoted obviously after crosslinking with water. The longer the time of water-crosslinking reaction undergoes, the more the tensile strength of composites promotes. Take the composites of content for 60% cellulose paper flour for example, the tensile strength of composites promotes from 12.8 MPa to 15.2 MPa (increases by 18.8%) after 4 hours of water-crosslinking treatment.

The formation of crosslinking network between the LLDPE and recycled PCB cellulose paper flour leads to the promotion of tensile strength. The effect of coincidence improves the interface between resin and fiber leading to the promotion of tensile strength. However, the silane coupling agent and compatailizer are able to effective strengthen the interfacial attraction between resin and cellulose, which resulted in increasing the mechanical properties, the elongation tends to reduce apparently as a result of the network structure formed after water-crosslinking reaction.

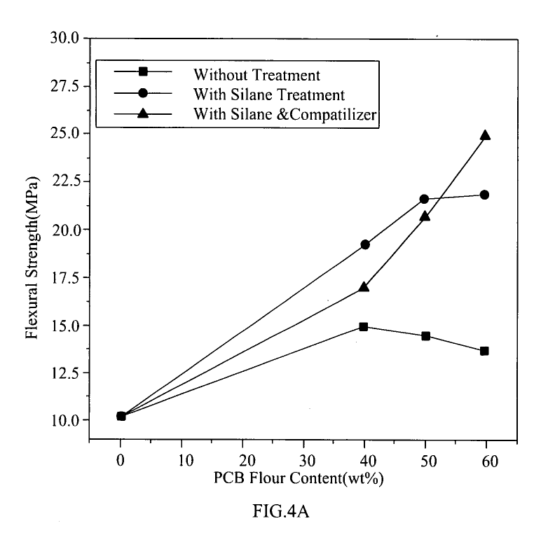

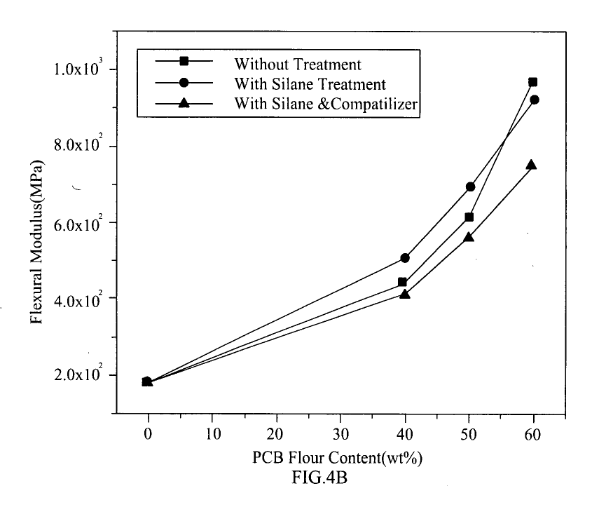

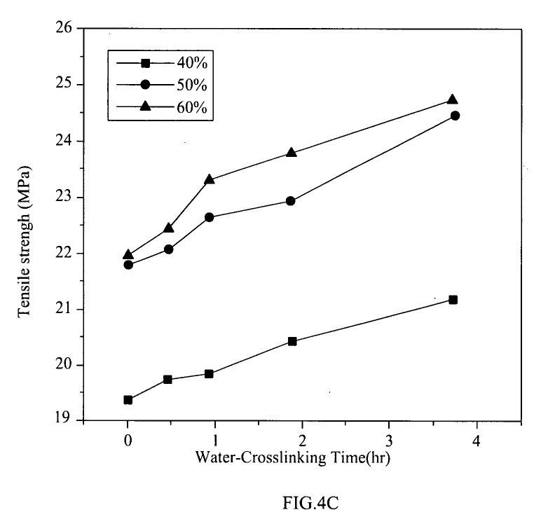

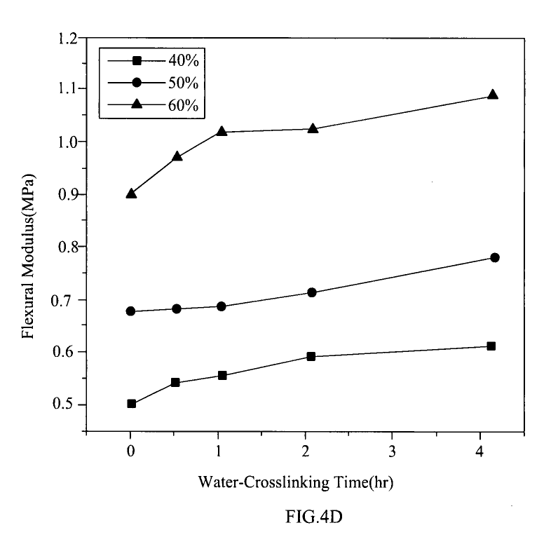

Please referring to FIG. 4A and FIG. 4B for a comparison table of the flexural strength and flexural modulus of PCB flour reinforced LLDPE composites with PCB flour for various water-crosslinking periods, in the FIG. 4A, [symbol] represents the flexural strength of unmodified PCB flour reinforced LLDPE composite, and [symbol] represents the flexural strength of PCB flour reinforced LLDPE composite with silane treatment, And [symbol] represents the flexural strength of PCB flour reinforced LLDPE composite with silane and 5 phr POE-G-Ma compatibilizer treatment.

In the FIG. 4B, [symbol] represents the flexural modulus of unmodified PCB flour reinforced LLDPE composite. [symbol] represents the flexural modulus of PCB flour reinforced LLDPE composite with silane treatment. [symbol] represents the flexural modulus of PCB flour reinforced LLDPE composite with silane and 5 phr POE-G-Ma compatibilizer treatment. Compared with FIG. 4A and FIG. 4B, the flexural strength of recycled PCB cellulose paper flour reinforced LLDPE composites with silane treatment, and with silane and compatibilizer treatment are both better than the flexural strength of recycled PCB cellulose paper flour reinforced LLDPE composites without treatment. And the flexural modulus promotes as the content of recycled PCB cellulose paper flour increases.

Please referring to FIG. 4C and FIG. 4D for a comparison table of flexural strength and flexural modulus of silane treated PCB flour reinforced LLDPE composites with various PCB flour contents for various water-crosslinking times, [symbol] represents the flexural strength of silane treated PCB flour reinforced LLDPE composites with 40% PCB flour, and [symbol] represents the flexural strength of silane treated PCB flour reinforced LLDPE composites with 50% PCB flour, and [symbol] represents the flexural strength of silane treated PCB flour reinforced LLDPE composites with 60% PCB flour. As shown in FIG. 4C and FIG. 4D, the longer the time of water-crosslinking reaction undergoes, the more the flexural strength and the flexural modulus promote.

Generally, a stress concentration occurs as the composite is stressed, and the filler plays the role to absorb the stress of the composite as a result of influence in the mechanical properties. Though the treatment with compatibilizer promotes the flexural strength of composites, the compatibilizer lowers the rigidity of the composites compared with the composite without treatment, because POE is an elastomer. The flexural strength promotes as the time of water-crosslinking reaction increases. When the PCB flour content reaches 60 wt % via 4 hours of water-crosslinking, the flexural strength is increased from 21.9 MPa to 24.8 MPa (increase by 13.2%) and the flexural modulus is increased from 0.922 GPa to 1.122 GPa (increase by 21.7%).

The treatment with the coupling agent and compatibilizer can effectively enhance the compatibility between LLDPE and recycled PCB cellulose paper flour, and both of them promote their tensile and impact strength. The recycled PCB cellulose paper flour with silane treatment forms a Si—O—C bonding between the interface of cellulose and the silane, and then, it will bond with the silane on the interface of cellulose to release the stress effectively leading to be provided with better mechanical properties and interface of composites. Besides, the proportion of the thermosetting flour of above-mentioned composites prefers between 10 wt % and 75 wt %.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A recycled thermosetting flour composite, including:
a plastic material;
(a) recycled thermosetting flour;
(b) an organic unsaturated silane; and
(c) a compatibilizer.

2. The recycled thermosetting flour composite of claim 1, wherein said plastic material is related to thermoplastic flour.

3. The recycled thermosetting flour composite of claim 2, wherein said thermoplastic flour is related to the polyolefin such as polyethylene (PE) or polypropylene (PP).

4. The recycled thermosetting flour composite of claim 1, wherein said recycled thermosetting flour includes the recycled phenolic cellulose paper, the epoxy resin-glass cloth laminate flour or recoveries concerned about SMC and BMC.

5. The recycled thermosetting flour composite of claim 1, wherein said organic unsaturated silane is related to be a chemical formula coincided with YRSiX3, which said X represents the hydrolytable alkoxy group, said Y represents a functional group, and said R represents a proper carbon chain.

6. The recycled thermosetting flour composite of claim 1, wherein said compatibilizer is related to which's chemical formula is R-g-X, in which said R is a macromolecule chain harmonized with the plastic material, in which said X is the functional group strongly reacted with —OH group such as MA and AA etc.

7. The recycled thermosetting flour composite of claim 1, wherein said organic unsaturated silane includes ethylene, propylene, 2-methylpropylene, pentane, 2-methylbutane.

8. The recycled thermosetting flour composite of claim 1, further including a cellulose filler, antiager, ultraviolet stabilizer, inorganic filler or fire retardant such as Mg(OH)₂, Al(OH)₃, phosphorous compound or nitrogen compound.

9. The recycled thermosetting flour composite of claim 1, wherein the proportion of said thermosetting flour prefers between 10 wt % and 75 wt %.

10. A method for preparing recycled thermosetting flour composites, including steps of:
(a) providing a plastic material, recycled thermosetting flour, an organic unsaturated silane and a compatibilizer;
(b) dispersing said organic unsaturated silane by using a dispersant for mixing with said thermosetting flour uniformly; and
(c) processing a water-crosslinking reaction with the mixture made from step (b) and said plastic material, to lead to said thermosetting flour and said plastic material formed a Si—O—Si bonding by way of silicon of said organic unsaturated silane to produce said composite.

11. The method of claim 10, wherein said dispersant is related to the acetone.

12. The method of claim 10, wherein the cost time of crosslink with water of said step b is 4 hours, and the temperature of water-crosslinking reaction of said step b is 700.

13. The method of claim 10, wherein said step (b) includes a reaction initiator which is related to dicumylperoxide, α-α-xylene, 2,5-dimethyl-2,5-dihexane, dibenzoxylperoxide, dicumylperoxide, 2-terbutylperoxide, terbutylcumylperoxide, peroxyterbutyltervalerate or peroxy-2-ethylterbutylcaproate.

14. The method of claim 10, wherein said organic metal compound is applied in said step b as a catalyst.

15. The method of claim 10, wherein said catalyst is related to dibutyltin dilaurate, dibutyltin diacetate, dibutyltin dicaprylate, stannous acetate, tetrabutyltitanate, lead naphthoate, zinc caprylate, calcium stearate, lead stearate, cadmium stearate.

16. The method of claim 10, wherein further including a step of adding a cellulose filler, antiager, ultraviolet stabilizer, inorganic filler or fire retardant such as Mg(OH)₂, Al(OH)₃, phosphorous compound or nitrogen compound.

17. The method of claim 10, wherein the proportion of said thermosetting flour prefers between 10 wt % and 75 wt %.
